(19) United States
(12) Patent Application Publication
(10) Pub. No.: US 2009/0137217 A1
(43) Pub. Date: May 28, 2009

(54) Communication transmission system and power detection method thereof

(76) Inventors: Chung-Er Huang, Taipei (TW); Sheng-Wen Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,026

(22) Filed: Nov. 27, 2007

(51) Int. Cl. H04B 1/04

(52) U.S. Cl. 455/126

(57) ABSTRACT

A communication transmission system is applied to an application device and includes a power detection circuit, and a radio frequency module. The power detection circuit is used for detecting the power on the output port of the communication transmission system, and for producing a feedback signal. The radio frequency module is connected to the power detection circuit for receiving the feedback signal so as to adjust its output power. In addition, the power detection circuit is built to be independent of the RF module for directly detecting the power on the output port of the communication transmission system which represents the actual power of the application device, thereby achieving the purpose of outputting a more stable and accurate output power through the RF module.

### BACKGROUND OF THE INVENTION

1. Field of the Invention

The present invention is related to a communication transmission system, and more particularly to a communication transmission system and a power detection method thereof, in which a power detection circuit is independent of a radio frequency module.

Recently, the matured communication transmission technology creates more and more demands for radio frequency modules, and many electronic products and electrical appliances have already integrated communication transmission technology, which becomes mainstream in the market.

2. Description of the Related Art

The radio frequency module is integrated in the application device in a modular manner for providing the application device with communication transmission capability. However, since consumer products become more and more exquisite with ever smaller dimensions, the radio frequency has to be miniaturized.

Therefore, a highly integrated radio frequency module was developed. The highly integrated radio frequency module serves to integrate all the needed chips, elements and circuit units into one single module, so as to save more space for the application device.

However, since the radio frequency module utilizes a power detection circuit to maintain its output power in a stable range. The power detection circuit built in the radio frequency module is a general design. The detect power is the radio frequency module's output power, but not the application device's output power, so that the radio frequency module might not be able to produce stable and accurate power if the output power for the application device is unstable or the system power is affected by subsystems, the other modules and elements in the application device.

### SUMMARY OF THE INVENTION

Therefore, in order to solve the problems described above. The present invention provides a power detection circuit which used for the communication transmission system of the application device. This circuit structure is simpler and independent of the radio frequency module. This detect circuit can support stable and accurate output power of the application device by the radio frequency module.

For achieving the object described above, the present invention provides a communication transmission system applied to an application device including a power detection circuit and an RF module. The power detection circuit is used for detecting the power on the output port of the communication transmission system, and for producing a feedback signal. The radio frequency module is connected to the power detection circuit for receiving the feedback signal so as to adjust an output power. In addition, the power detection circuit is built to be independent of the RF module for directly detecting the power on the output port of the communication transmission system which represents the actual power of the application device and not just the output power from the RF module.

For achieving the object described above, the present invention provides a power detection method for a communication transmission system to be applied to an application device, wherein the communication transmission system includes a power detection circuit and an RF module. The method includes steps of: producing an output power through the RF module, and detecting the power of an RF antenna of the application device through the power detection circuit so as to produce a feedback signal to the RF module, wherein the power detection circuit is independent of the RF module for directly detecting the power on the output port of the communication transmission system, thereby the RF module is capable of receiving the feedback signal for adjusting the output power. Hence, the power detection circuit in the communication transmission system can completely detect the actual power of the application device, so that the RF module can provide a more stable and accurate output power.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a block diagram showing an exemplary embodiment of a communication transmission system according to the present invention;

FIG. 2 is a schematic view showing a radio frequency module of the communication transmission system in an embodiment of the present invention;

FIG. 3 is a circuit diagram showing a power detection circuit in a first embodiment of the present invention; and

FIG. 4 is a circuit diagram showing a power detection circuit in a second embodiment of the present invention.

### DETAILED DESCRIPTION OF PREFERRED EMBODIMENTS

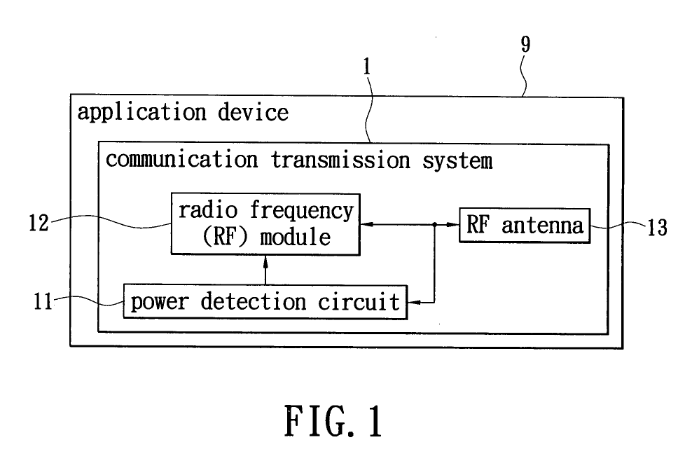

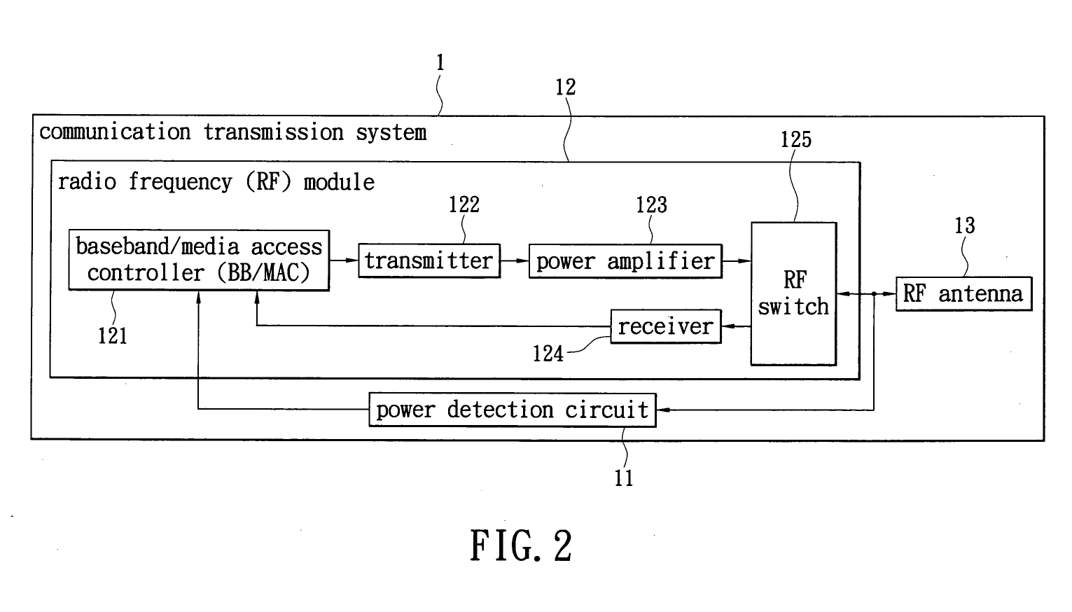

Please refer to FIG. 1 and FIG. 2, which are respectively a block diagram showing the communication transmission system in an exemplary embodiment of the present invention and a circuit diagram showing the radio frequency module in the embodiment shown in FIG. 1. As shown, the communication transmission system 1 is provided by the present invention in order to give communication transmission capability to an application device 9.

A communication transmission system 1 includes a power detection circuit 11, an RF (radio frequency) module 12 and an RF (radio frequency) antenna 13, wherein the RF module 12 is connected to the RF antenna 13 for transmitting an output power to transmit a communication signal and for receiving an RF data signal, thereby achieving a bidirectional communication signal.

Therefore, the RF antenna 13 is namely the input port and also the output port of the communication transmission system 1 for receiving and transmitting RF signals.

The power detection circuit 11 is connected or coupled to the RF antenna 13, and since the power detection circuit 11 is built to be independent and not in the RF module 12, even if the power detection circuit 11 and the RF module 12 are connected to the RF antenna 13 at the same time, the power detection circuit 11 still can detect the power at the RF antenna 13 of the communication transmission system which belongs to the entire application device, so as to produce a feedback signal. In other words, the power of the application device 9 detected by the power detection circuit 11 includes not only the output power of the RF module 12, but also the power alternation caused from the antenna 13 being influenced by the subsystems, module or elements in the application device 9, so that the power detection circuit 11 can generate the feedback signal to the RF module 12. Furthermore, in practice, the power detection circuit 11 generally will be located near the RF antenna 13 for further ensuring that the detected power is close to the final output power.

Consequently, between the RF module 12 and the power detection circuit 11, a close loop is formed, wherein the RF module will adjust the magnitude of the output power according to the feedback signal generated by the power detection circuit 11, so as to conform to the required output power of the communication transmission system 1.

Moreover, FIG. 2 explains the detail architecture of the RF module 12. In the RF module 12, all the units and elements needed for operating RF function are included, and the connection relationship between the power detection circuit 11 and the RF module 12 is also disclosed. However, since the RF module's design might be different according to different manufacturers, the actual details can be altered. As shown in FIG. 2, the RF module 12 includes a baseband/media access controller (BB/MAC) 121, a transmitter 122, a power amplifier (PA) 123, a receiver 124 and an RF switch 125. Here, the transmitter 122 and the receiver 124 also can be replaced by a transceiver, and the RF switch 125 can be a single pole double throw switch, a duplexer, or a diplexer.

The BB/MAC 121 utilizes the DC pulse to transmit signal and the data signal is transmitted on the transmission media in a separate pulse state, so that, according to the feedback signal generated by the power detection circuit 11, a control signal can be produced for controlling the power of an RF signal. The transmitter 122 is connected to the BB/MAC 121 for transmitting the RF signal. The power amplifier 123 is connected to the transmitter 122 for amplifying the power of the RF signal before transmission, so as to form the output power. Oppositely, the receiver 124 is used for receiving an external RF data signal 1 and providing it to the BB/MAC 121 for further processing.

The RF switch 125 is connected at one end to the power amplifier 123 and the receiver 124, and the other end is connected to the RF antenna 13, so that the power amplifier 123 and the receiver 124 respectively can utilize the antenna 13 to transmit and receive RF signals. Therefore, through the power detection circuit 11 constantly detecting the power of the application device (including the output power of the RF module 12 and the power alternation caused from couplings to the application device 9), the RF module 12 can be controlled to output a stable and accurate output power.

Besides, except for highly integrated design, the RF module also can be a module IC with integrated peripheral circuit (IPC), so as to further reduce the size of the module.

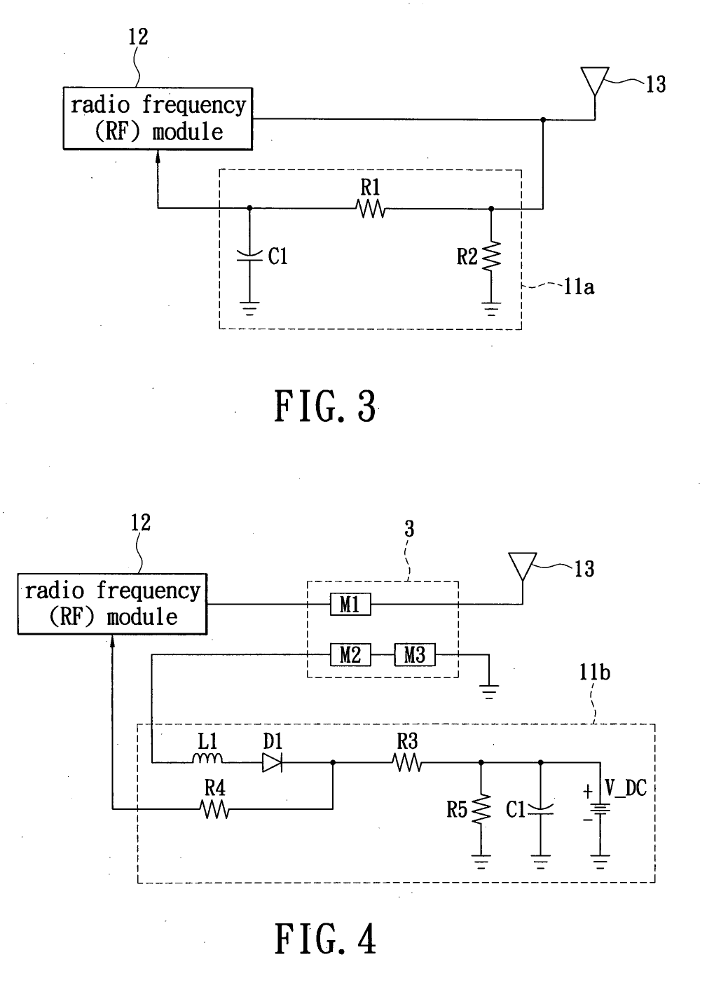

Furthermore, please refer to FIG. 3 and FIG. 4, which are schematic representations of a first and a second embodiment of the power detection circuit of the present invention. The difference between the power detection circuits 11a, 11b in FIG. 3 and FIG. 4 is that the power detection circuit 11a is simply connected to the RF antenna 13 and the RF module 12 and is independent in detecting the power at the RF antenna 13 of the application device 9, so as to provide the RF module 12 the adjustment base. As to the power detection circuit 11b in FIG. 4, it is coupled to the output port of the RF module 12 and the RF antenna 13 through a directional coupler 3 for detecting the output power of the RF module 12, wherein the direction coupler includes a main line M1, a first secondary line M2 and a second secondary line M3. When there is noise produced at the antenna 13, according to the characteristic of the directional coupler 3, the noise will be directly coupled to ground through the second secondary line M3 until the power detection circuit 11b can have a clean power of the application device 9 for providing feedback signal to the RF module 12.

In addition, when transmitting the output power, to avoid the RF module from forming reflection waves feeding into the power detection circuit 11b through the directional coupler 3 resulting in an inaccurate detection result, the lengths of the main line M1 and the first secondary line M2 in the directional coupler 3 are designed to be a multiple of quarter wavelength. As a result, when the output power passes the directional coupler 3, a feedback effect can be formed, such that the main line M1 will be coupled to the first secondary line M2 for shunting to the power detection circuit 11b, and the reflection wave which will influence the output of the RF module 12 will not be produced in the directional coupler 3.

One skilled in the art should be appreciated that the power detection circuit 11a, 11b described in FIG. 3 and FIG. 4 are only for illustration, and other designs of power detection circuits also can achieve identical effect.

In the aforesaid, according to the communication transmission system and its power detection circuit of the present invention, the power detection circuit is built to be independent of the RF module, such that the power detection circuit can directly and completely detect the power of the application device, so as to correctly adjust the output power of the RF module, thereby outputting a more stable and more accurate output power through the RF module. Besides, not only the RF module is simplified, the power detection circuit also becomes more compact and independent, so that the power detection circuit can have different designs corresponding to different application devices.

It is to be understood, however, that even though numerous characteristics and advantages of the present application have been set forth in the foregoing description, together with details of the and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A communication transmission system with a power detection function, comprising:
a power detection circuit, for detecting a power on an output port of the communication transmission system and producing a feedback signal; and
an RF module, connected to the power detection circuit for receiving the feedback signal in order to adjust the output power, wherein the power detection circuit is built to be independent of the RF module for directly detecting the power on the output port of the communication transmission system.

2. The communication transmission system as claimed in claim 1, wherein the communication transmission system further comprises an RF antenna connected to the RF module for receiving and transmitting an RF signal.

3. The communication transmission system as claimed in claim 2, wherein the power detection circuit is connected or coupled to the RF antenna for detecting the power on the output port of the communication transmission system.

4. The communication transmission system as claimed in claim 3, wherein the power detection circuit is coupled to the RF antenna and the RF module through a directional coupler, and the directional coupler conducts noise produced by the RF antenna to ground.

5. The communication transmission system as claimed in claim 1, wherein the RF module comprises:
a baseband/media access controller (BB/MAC), which transmits a control signal in accordance with the feedback signal for controlling the power of an RF signal;
a transmitter, connected to the BB/MAC for transmitting the RF signal;
a power amplifier, connected to the transmitter for amplifying the power of the RF signal so as to form the output power; and
a receiver, for receiving an RF data signal to provide to the BB/MAC for further processing.

6. The communication transmission system as claimed in claim 5, wherein the RF module further comprises an RF switch connected to the power amplifier, the receiver and the RF antenna, so that the transmission and the receiving respective of the power amplifier and the receiver are achieved through the RF antenna.

7. The communication transmission system as claimed in claim 6, wherein the RF switch is a single pole double throw switch, a duplexer or a diplexer.

8. The communication transmission system as claimed in claim 1, wherein the RF module is an integrated peripheral circuit module IC.

9. A power detection method for a communication transmission system including an RF module and a power detection circuit, the method comprising steps of:
producing an output power through the RF module; and
detecting the power of an RF antenna in the communication transmission system through the power detection circuit so as to produce a feedback signal to the RF module,
wherein the power detection circuit is independent of the RF module for directly detecting the power of the RF antenna in the communication transmission system, thereby the RF module is capable of receiving the feedback signal for adjusting the output power.

10. The method as claimed in claim 9, wherein the RF antenna is connected to the RF module for transmitting its output signal.

11. The method as claimed in claim 9, wherein the power detection circuit is connected or coupled to the RF antenna for detecting the power of the RF antenna in the communication transmission system.

12. The method as claimed in claim 9, wherein the RF module is an integrated peripheral circuit module IC.
